(19) United States
(12) Patent Application Publication
(10) Pub. No.: US 2023/0084134 A1
(43) Pub. Date: Mar. 16, 2023

(54) METHOD AND COMPUTING APPARATUS FOR DETERMINING SHAREHOLDER IDENTITY

(71) Applicant: SRAX, Inc., Westlake Village, CA (US)

(72) Inventors: Christopher O'Neil, Westlake Village, CA (US); Christopher Miglino, Westlake Village, CA (US); Terry Lei, Westlake Village, CA (US); Emily Behlmann, Westlake Village, CA (US)

(73) Assignee: SRAX, Inc., Westlake Village, CA (US)

(21) Appl. No.: 17/505,047

(22) Filed: Oct. 19, 2021

Related U.S. Application Data
(60) Provisional application No. 63/241,219, filed on Sep. 7, 2021.

(51) Int. Cl. G06Q 10/06; G06Q 40/04

(52) U.S. Cl. CPC G06Q 10/06375; G06Q 40/04

(57) ABSTRACT

A method and computing apparatus for determining shareholder identifiers associated with the significant event occurrence a is described. The method and computing apparatus determines a significant event occurrence associated with a change in a daily closing share count, obtains shareholder records associated with the significant event occurrence, and identifies at least one reference record for each obtained shareholder record based on a share count range and a custodian identifier.

### CROSS-REFERENCE TO RELATED APPLICATIONS

The present application claims priority to U.S. Provisional Patent Application No. 63/241,219, filed Sep. 7, 2021, the content of which is incorporated herein in its entirety by reference for all purposes.

### BACKGROUND

The stock market has both a primary and secondary marketplace where numerous financial instruments (e.g., warrants, discounts, puts, calls, convertible debt, etc.) are available to short term traders and long term investors to utilize as a platform for investing and forecasting risks to maximize profits. The underpinnings of these financial instruments are the stocks of a publicly traded company.

One of the primary reasons for companies to offer shares to the public is to raise funds from outside investors. In return, the company's founders and/or current owners relinquish part of their ownership to these new investors. Generally, the executives of a publicly listed company should ensure the company has access to capital but in the most equitable terms for all shareholder constituencies, including both short term traders and long-term investors.

The CEO/CFO must understand how their stock value is being leveraged and impacted by its participation in these capital raising instruments. That is, knowing specific investors and their trading history is useful to the company. However, this understanding has many challenges due to the complexities of trading strategies and the potential anonymity of the shareholder constituencies. For example, investor identity is generally known to privately held companies by virtue of not being traded on a public market. Additionally, companies know investor identities when issuing securities in a primary marketplace, e.g., through a private investment in public equity offering or PIPE.

However, once stock is traded on the secondary market, investor identity data associated with Non-Objecting Beneficial Owners or (NOBOs) can be obtained publicly. In particular, a NOBO elects that an intermediary can release their private personal information such as their name, address, and number of shares owned to the issuer. By contrast, at least half of all investors participating in primary security offerings, are either exempt from reporting regulations or choose to opt-out of such disclosures. For example, investors may elect Objecting Beneficial Owner (OBO) status to keep their financial holdings private, by instructing the financial intermediary not to provide their personal information to the securities issuer. Methods that track investor trading activity to determine potential investors impacting company's stock price are needed.

### SUMMARY

In accordance with one or more embodiments, various features and functionality are provided to enable investor-impact forecasting by identifying likely investors affecting a company's stock price based on monitoring trading activity.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an example custodian identifier system, according to an implementation of the disclosure.

FIG. 2 illustrates an example set-up process, according to an implementation of the disclosure.

FIGS. 3A-3B illustrate an example baseline report process, according to an implementation of the disclosure.

FIG. 3C illustrates an example baseline report, according to an implementation of the disclosure.

FIG. 4A illustrates an example custodian share regression, according to an implementation of the disclosure.

FIG. 4B illustrates an example histogram of the number of shareholders that own the binned number of shares for an underlying security, according to an implementation of the disclosure.

FIG. 4C illustrates an example box plot generated from time-series data analyses, according to an implementation of the disclosure.

FIG. 5 illustrates an example custodian identifier process, according to an implementation of the disclosure.

FIGS. 6A-6B illustrate example reports demonstrating results of a custodian identifier method using the NOBO approach, according to an implementation of the disclosure.

FIG. 7 illustrates an example monitoring process, according to an implementation of the disclosure.

FIG. 8 illustrates an example attribution process, according to an implementation of the disclosure.

FIGS. 9A-9D illustrate an example investor candidate presentation, according to an implementation of the disclosure.

FIG. 10A illustrates an example share count statistics for a given custodian, according to an implementation of the disclosure.

FIG. 10B illustrates an example probability density function and cumulative distribution function as a function of the number of shares owned by an investor according to an implementation of the disclosure.

FIG. 10C illustrates an example share range histogram tabulated in table format, according to an implementation of the disclosure.

FIG. 11 illustrates an example computing system that may be used in implementing various features of embodiments of the disclosed technology.

### DETAILED DESCRIPTION

Described herein are systems and methods for improving investor impact forecasting by identifying likely investors affecting a company's stock price based on monitoring trading activity. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

Not all investors choose to disclose their identity after acquiring stock through participating in a primary securities offering or other acquisition event that requires the company to know investor identities. Often, more influential anonymous investors are the ones who participate in the primary securities offerings and while their complex investment strategies are not disclosed during the transaction, it is known that their investment strategies and financial instruments are often related and there exists informative signals in the relationships between an investor and the financial terms of their negotiations. Moreover, the buying and selling behavior of each investor may be used to identify connections between investors and their deal terms, e.g., when the stock price reaches a warrant strike price and the investor executes the warrant.

Unfortunately, investor buying and selling behaviors may be difficult to capture because of limited data availability. Moreover, even when the data is available the rate with which trading data should be sampled is unknown. Currently available software tools simply aggregate shareholder data from multiple sources (e.g., NOBO, Securities Position Reporting (SPR), share range analysis and similar public data sources). Existing solutions fail to track investor activity when an investor requests to keep its information private.

In accordance with various embodiments, a system and method for assisting in determining investor identity based on monitoring trading activity of the most influential investors is disclosed. In one embodiment, the method is configured to perform an initial “set-up” process, during which investor profiles of known and unknown investors are obtained and analyzed to establish investor (shareholder) baseline, iteratively monitor features associated with the profiles by utilizing a Temporal Attention Mechanism (TAM), and, finally, determine a set of likely investor candidates whose holdings have likely changed along with relevant investment, market, and economic data. Further still, the method is configured to present the set of investor candidates to an operator user (e.g., a financial analyst, CEO/CFO) who then may finalize investor candidacy by attributing buying/selling behavior.

As will be described in detail below, the method addresses issues related to limited data (e.g., due to investor anonymity and lack of intraday trading activity) and unknown sample rate. In particular, the sampling rate issue is the rate with which the system requests shareholder and custodian time-series data to capture significant events related to share count changes. For example, if the frequency with which the time-series data is requested is too low, then shareholder ownership tracking becomes impossible. By contrast, if the frequency is too high, then the system is inundated with data which increases storage and processing costs and reporting fees paid to third parties or custodians to receive various reports. The present embodiments resolve the sampling rate problem by determining likely significant changes to custodian share range by analyzing one or more trends related to custodian share count, share range trends, and/or other similar time-series data.

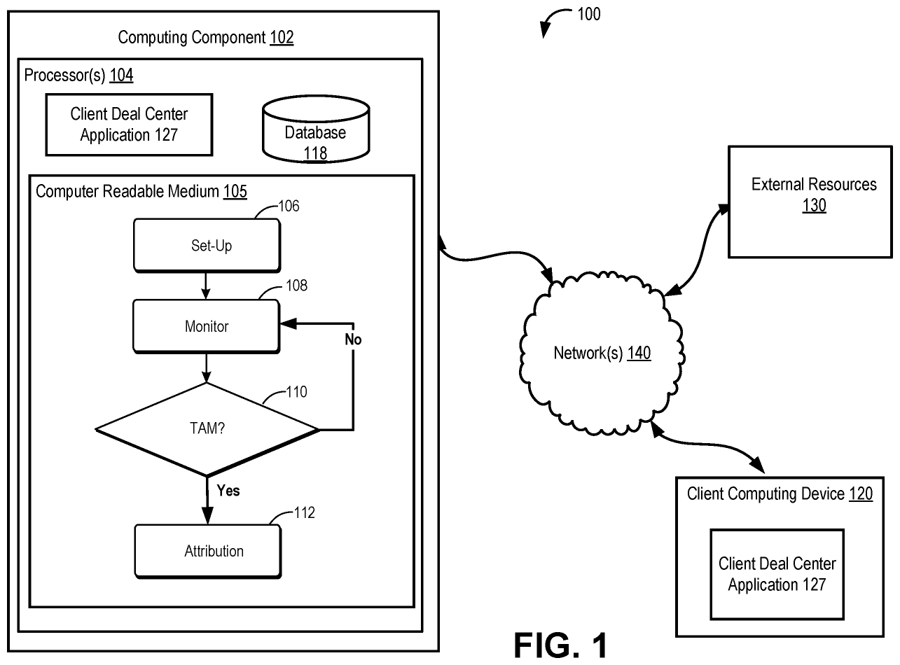

FIG. 1 illustrates a custodian identifier system 100, in accordance with the embodiments disclosed herein. This diagram illustrates an example system 100 that may include a computing component 102 in communication with a network 140. The system 100 may also include one or more external resources 130 and a client computing device 120 that are in communication with network 140. External resources 130 may be located in a different physical or geographical location from the computing component 102.

As illustrated in FIG. 1, computing component or device 102 may be, for example, a server computer, a controller, or any other similar computing component capable of processing data. In the example implementation of FIG. 1, computing component 102 includes a hardware processor 104 configured to execute one or more instructions residing in a machine-readable storage medium 105 comprising one or more computer program components.

Hardware processor 104 may be one or more central processing units (CPUs), semiconductor-based microprocessors, and/or other hardware devices suitable for retrieval and execution of instructions stored in computer readable medium 105. Processor 104 may fetch, decode, and execute instructions 106-112, to control processes or operations for determining investor identity. As an alternative or in addition to retrieving and executing instructions, hardware processor 104 may include one or more electronic circuits that include electronic components for performing the functionality of one or more instructions, such as a field programmable gate array (FPGA), application specific integrated circuit (ASIC), or other electronic circuits.

A computer readable storage medium, such as machine-readable storage medium 105 may be any electronic, magnetic, optical, or other physical storage device that contains or stores executable instructions. Thus, computer readable storage medium 105 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 105 may be a non-transitory storage medium, where the term “non-transitory” does not encompass transitory propagating signals. As described in detail below, machine-readable storage medium 105 may be encoded with executable instructions, for example, instructions 106-112.

As noted above, hardware processor 104 may control processes/operations for determining investor identity by executing instructions 106-112. Hardware processor 104 may execute instruction 106 to perform the set-up process. The set-up process may begin by acquiring shareholder profiles of known and unknown shareholders and through a series of protocols and identifies the custodian for each shareholder. The set-up process may end when the system 100 has determined a breakdown of existing shareholders and determined one or more patterns of fluctuation of shares held by each custodian.

Hardware processor 104 may execute instruction 108 to perform the monitoring process. The monitoring process may begin upon completing the set-up process. During the monitoring process, features of shareholder and custodian profiles may be actively monitored utilizing a Temporal Attention Mechanism (TAM). The monitoring process may be iterative and continue until an event determined by TAM (e.g., a TAM Event) is detected upon executing instruction 110 by hardware processor 104. Hardware processor 104 may execute instruction 112 to perform the attribution process upon detecting the TAM event. The attribution process may generate and present the user with a set of likely investor candidates that the user will then finalize by making a final investor candidacy determination by attributing each investor candidate's buying/selling behavior.

In some embodiments, the set-up process may be triggered upon creating a profile for a company that recently went through a primary security offering within the system 100. For example, information related to a new company may be entered via a graphical user interface of a deal center client application 127 running on the client computing device 120 and communicating with computing component 102 via network 140.

In a primary security offering, such as a private investment in a public equity (PIPE), a company sells its shares directly to investors rather than through intermediaries such as a stock exchange or a wholesaler. Because the shares are sold to investors directly, the company (i.e., the issuer of the shares) must be able to verify the identity of investors to ensure regulatory investor accreditation and other requirements are met. Thus, in a PIPE transaction, the company is required to receive the identity information associated with each investor who obtained shares. Once the shares are sold, the company transfers the shares to the custodian specified by the investor. Accordingly, in a PIPE transaction, the investor, the shares, and the custodian are all known to the company at the time the securities are issued. Of course, subsequently, a shareholder may object to disclosure of its identity and request OBO status. This designation by an investor to OBO status makes it difficult for the company to track individual investor trading activity using publicly available trading information, such as a Securities Position Reporting (SPR). This is especially true for an OBO investor that changes its original holding position (e.g., buying and selling) and/or moves shares to one or more different custodians. It may be possible to determine a potential investor candidate by simply “matching” an influential OBO investor with a PIPE investor, having the same share count and custodian information, by virtue of having a relatively small number of such influential investors. However, once the original PIPE investors who have elected OBO status, start participating in the public secondary market through buying and/or selling and transferring shares across multiple custodians, relying on matching is not effective. To further complicate the matter, additional investors who were not part of the PIPE or other offering may buy shares on the secondary market, whose identity may be unknown to the company.

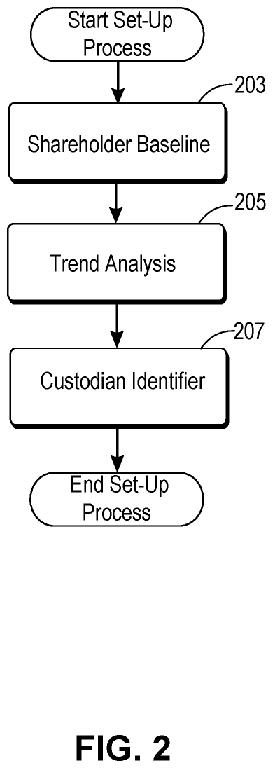

Creating a company profile and obtaining the initial shareholder, share number, and custodian information, to which the company is privy, as described above, may initiate the setup process which itself may comprise a number of sub-processes. For example, FIG. 2 illustrates the operations of the set-up process. In this particular example, the set-up process (performed by executing instructions 106 in FIG. 1) may include a shareholder baseline process 203, a trend analysis process 205, and a custodian identifier process 207.

The shareholder baseline process 203 may be configured to obtain shareholder data from one or more sources during one or more time periods. For example, shareholder baseline process 203 may obtain publicly available shareholder data (e.g., financial data, corporate entity information that is filed with the Securities and Exchange Commission (SEC), NOBO Report, OBO Report, SPR, etc.) from an external resource (e.g., external resource 130 in FIG. 1).

Each time shareholder data is obtained it represents a snapshot of the company's share ownership at a particular time (time-series). Shareholder data associated with a PIPE transaction will always include the shareholder identity, share count, and custodian information, while shareholder data obtained any time after the initial PIPE transaction may not reveal identity information (e.g., by virtue of investors electing OBO status).

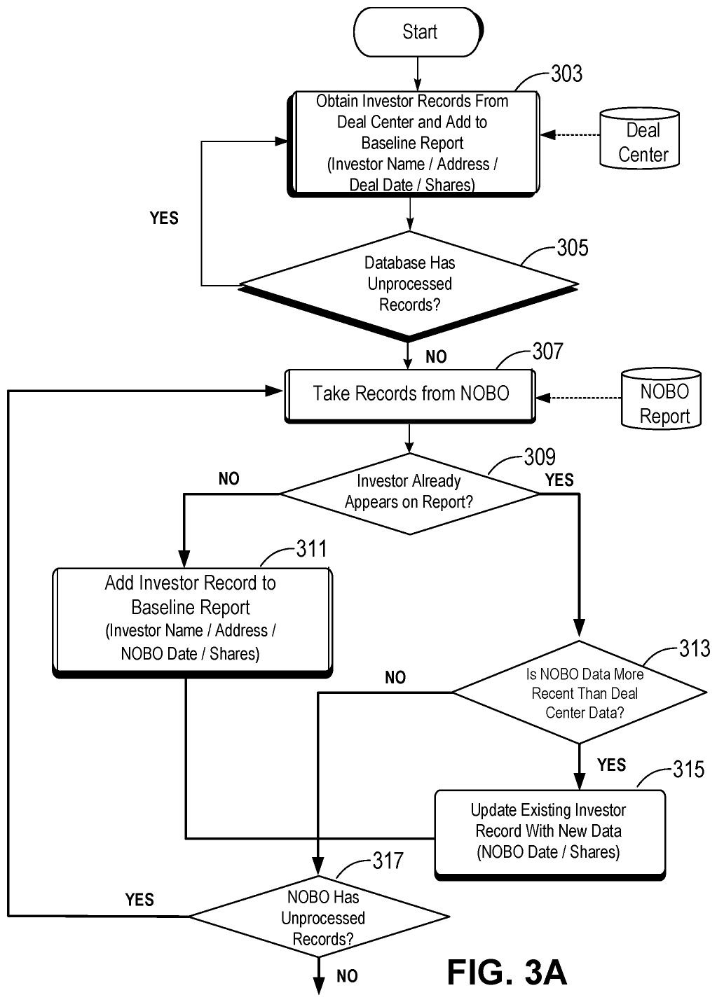

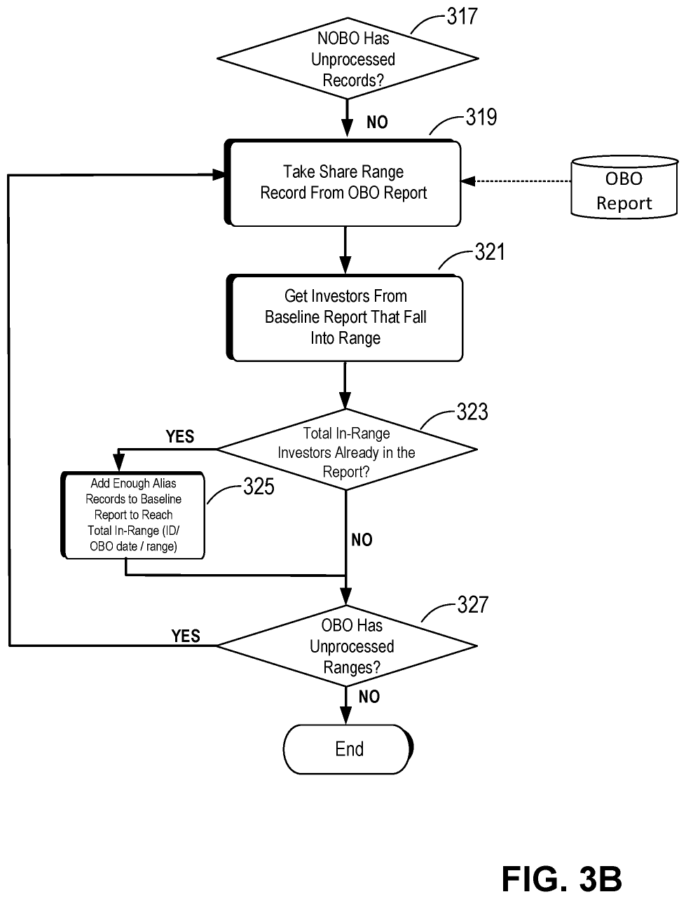

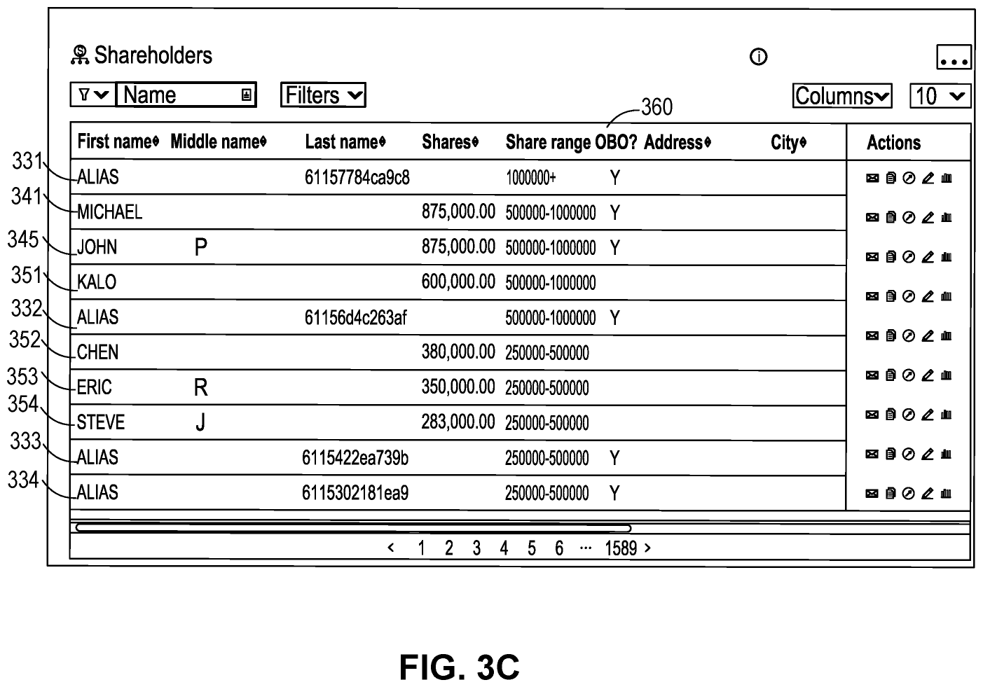

The shareholder baseline process 203 may be configured to generate a baseline shareholder trend report using the known PIPE data and subsequent time-series ownership data. An example baseline report process is illustrated in FIGS. 3A-3B. As illustrated in FIG. 3A, in block 303, the baseline report is populated with information from the PIPE transaction, for example stored in the Deal Center application database. If all PIPE records have been added to the baseline report, as determined in 305, then records from a NOBO report are obtained in 307. As explained above, a NOBO report will identify investors. Upon determining that a shareholder on the NOBO report corresponds to a shareholder already added to the baseline report in 309, NOBO data is used to update existing investor records with more recent NOBO data in steps 313 and 315. Alternatively, new NOBO records are added to the baseline report in 311. These shareholder records are known as identified NOBO investors.

If all NOBO records have been processed, as determined in 317, then records from OBO report are obtained in 319, as illustrated in FIG. 3B. In block 319, share range records are obtained from the OBO report. As explained above, an OBO report will not identify specific investors, rather, it will report ownership within a particular share range (e.g., 500,000-1,000,000 share range). In block 321, all shareholders in the baseline report that meet the share range of the OBO records are obtained. Upon determining that the OBO share-range records exceed existing baseline report records in block 323, alias records are added to the baseline report to represent these anonymous owners in block 325. These shareholder records are known as unidentified anonymous OBOs. Conversely, if no OBO share-range records exceed existing baseline report records in block 323, a determination whether the OBO has remaining unprocessed ranges is made in block 327. If all records have been processed, the shareholder baseline process ends. Alternatively, share range records are obtained from the OBO report are obtained for any unprocessed records processed are taken (back to block 319), as discussed above.

FIG. 3C illustrates the shareholder baseline report generated by the shareholder baseline process illustrated in FIGS. 3A-3B and described above. In this particular example, records 331, 332, 333, 334 may correspond to shareholders categorized as unidentified anonymous, records 341, 345 as identified-anonymous; and records 351, 352, 353, 354 as identified. Unidentified anonymous shareholders 331, 332, 333, and 334 are identified by an alias and have been added to the baseline report by analyzing share-range records and determining that these share-ranges are not associated with a previously identified investor, as described above. Identified anonymous shareholders 341, 345 are identified using their previously known identity but are tagged with “Y” in the OBO field 360 signifying objection to disclosure. Identified shareholders 351, 352, 353, 354 are non-objecting and thus are identified using information obtained from the NOBO report, which is known. In particular, because the NOBO report is usually requested less frequently (e.g., monthly or even annually) due to its costs, any tracking of shareholder activity by only relying on the NOBO report is generally meaningless by virtue of its low frequency. That is, the company would miss a number of buying and selling events if it only looked at the trading activity once a year. Additionally, requesting the NOBO report is expensive. In accordance with various embodiments, the method described further below will provide company's management with a way to track trading activities of these investors without reliance on the NOBO.

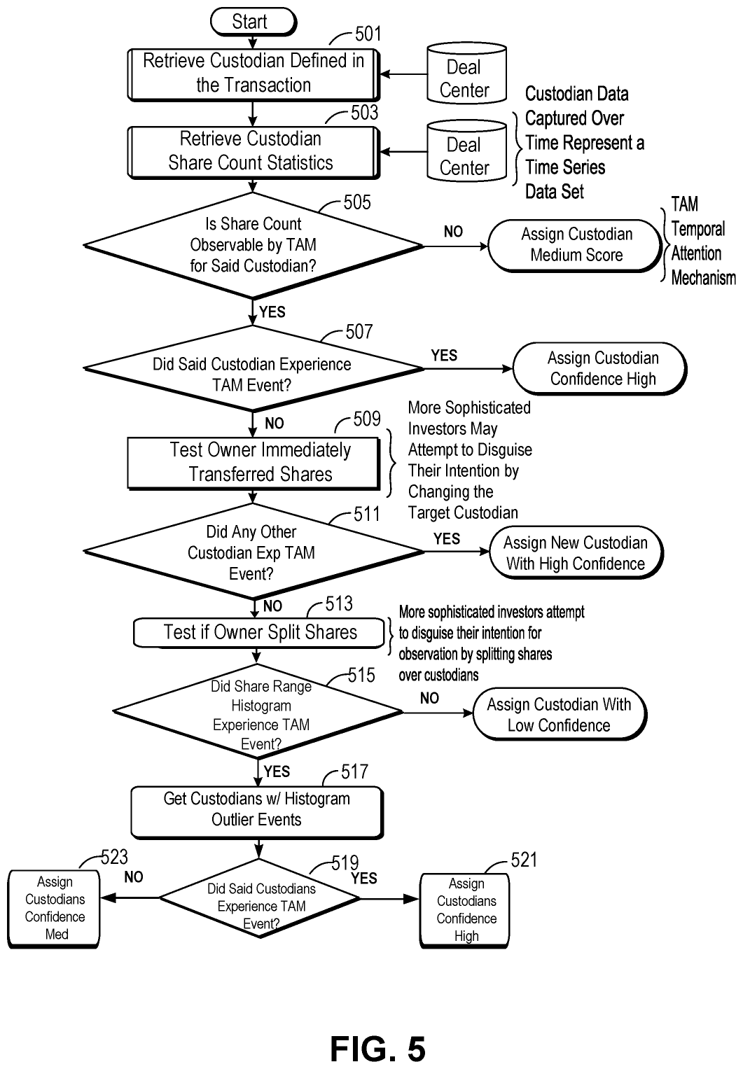

Referring back to FIG. 2, the next step in the set-up process (illustrated in FIG. 1) is the trend analysis process 205. The trend analysis process 205 may be configured to track one or more trends related to custodian share count, share range trends, and/or other similar time-series data. By determining a baseline signal first, the present system may detect future TAM Events, as described with respect to FIGS. 5, 7, and 8. In essence, the trend analysis process determines a likelihood that a TAM Event is going to occur thereby providing a solution to the sampling frequency.

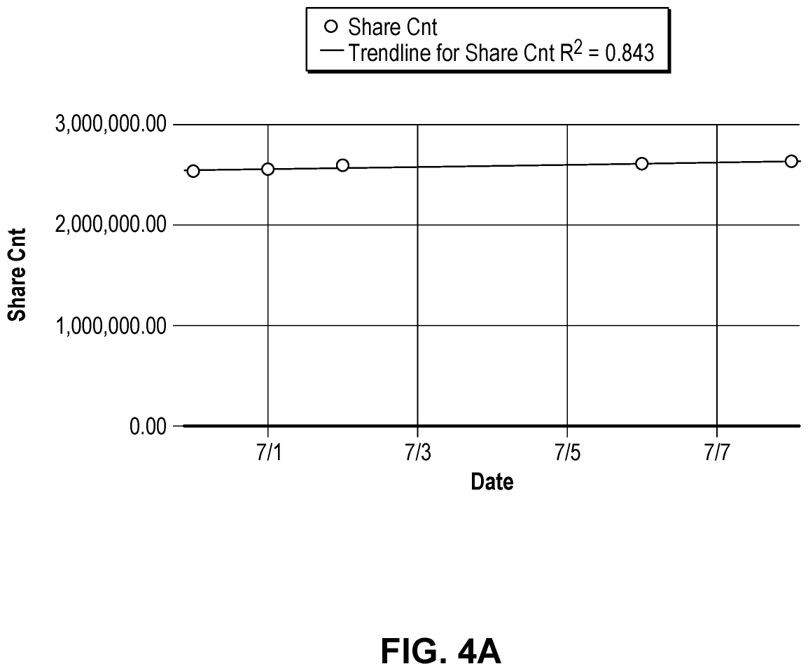

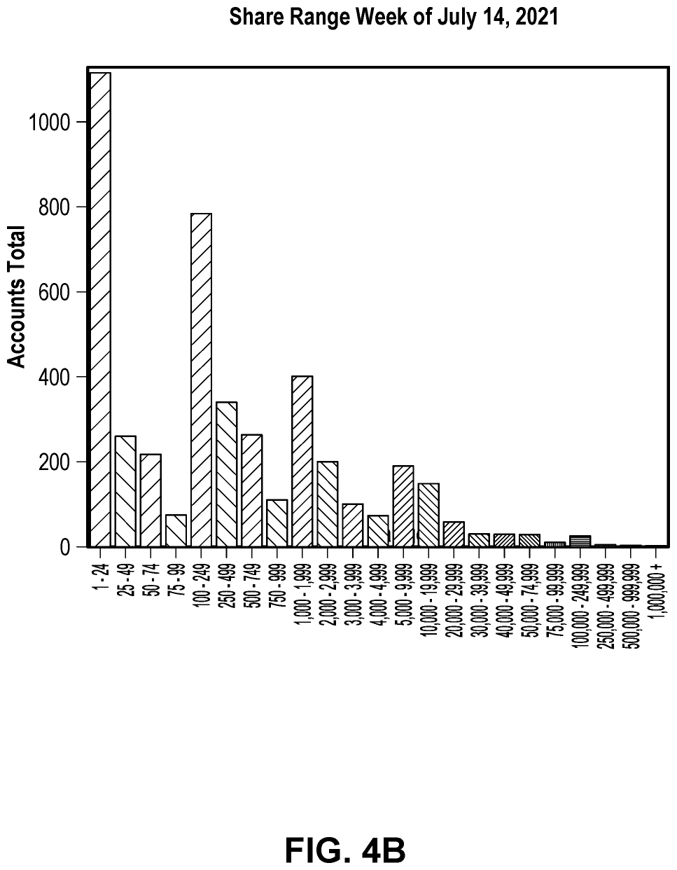

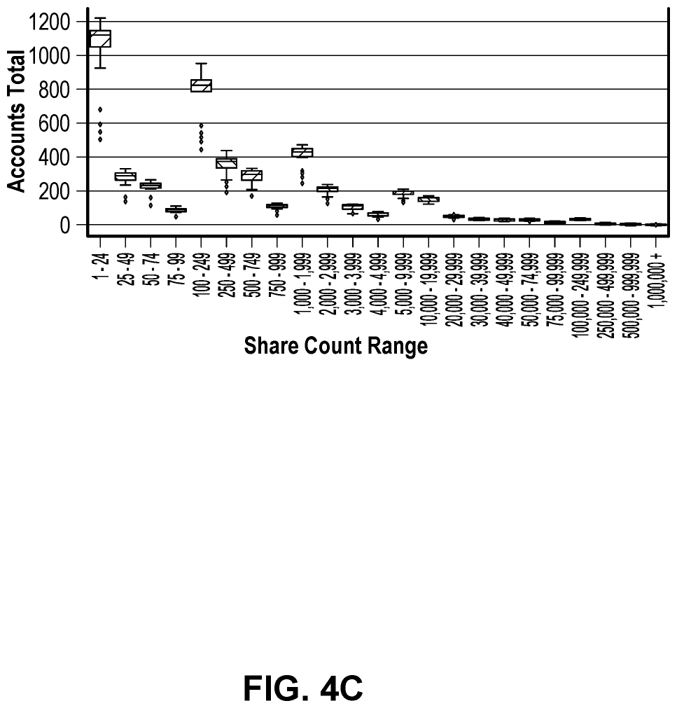

The custodian share count refers to the share number a particular custodian may hold at any given time. The number of shares a particular custodian holds at a particular time tends to strongly correlate with the future number of shares. That is to say, the total number of shares held by a custodian tends to stay the same over time. A linear regression analysis applied to custodian share count values in a particular time period is associated with having a high R² value. For example, as illustrated in FIG. 4A, the share counts collected over a week have R² value of 0.843. Referring back to FIG. 2, the trend analysis process 205 exploits this characteristic of custodian share count (e.g., a high R² value) and tracks share count at each custodian that holds the company's shares to determine if any statistically significant events have occurred. For example, a custodian having a significant reduction or increase in shares may be such an event. In some embodiments, the trend analysis process 205 may use TAM to determine a specific activity in the time-series data. The TAM learns to weigh critical days that impact the future share count prediction resulting in an optimization of the data acquisition cost. The optimization is achieved by considering several statistical features of the time-series data for share count in the custodian, such as the statistical outlier or confidence levels. For example, high pass filtering, numerical differentiation using various finite differences methods such as two-point estimation, symmetric difference, and other higher order methods could be used. In addition, if higher order derivatives are needed, these can be approximated as well using standard numerical techniques. In some embodiments TAM applies high-pass filtering on the custodian data in order to clean up the noise in the low value trends from the time-series data, and produces a local approximation of that to optimize the outcomes. To estimate a population mean μ for each custodian, in some embodiments a collection of random samples of data c₁, c₂, c₃, . . . from the historical custodian time-series data may be used. One possible estimate of μ, which is the sample mean or first moment is:

$$μ = \frac{1}{N} {\sum }_{i = 1}^{N} {c}_{i}$$

In some embodiments, μ can then be used to analyze the linear regression and generate a signal indicative of statistically significant events that may have occurred over a particular index of the time-series data. Depending on the initial sampling frequency, if a TAM event has occurred, in some embodiments, additional SPR reports may be ordered to fill-in the missing time-series data.

Similarly, the trend analysis process 205 may track the changes in the share range analysis report to determine occurrence of statistically significant changes in share ownership. The share range analysis report is available to publicly traded companies on a weekly basis. The share range analysis report provides a breakdown of shareholders by share range. An example share range report is illustrated in FIG. 4B. There are twenty-three share ranges. The first share range includes shareholder accounts that each own between 1 and 24 shares. Conversely, the twenty-third (i.e., the last share range) share range includes accounts that own over 1,000,000 shares. In this particular example, each bar represents shareholder counts per share range for a particular week (in this case Jul. 14, 2021). As shown in the share range report, shareholders holding relatively small counts are much more common than those holding large counts of shares. Further, time-series data associated with weekly share ranges indicates that fluctuations in shareholder counts are much more common in the smaller ranges, while the shareholder count for the upper ranges tends to remain steady. For example, as illustrated in FIG. 4C, the share ranges collected over a 6-month period corresponding to higher share counts (e.g., share counts over 250,000 shares) have lower fluctuations. Referring back to FIG. 2, the trend analysis process 205 exploits this characteristic of share range analysis (e.g., low fluctuation and low probability of fluctuation at high shareholder range) and tracks share count in the upper ranges to determine if any statistically significant events have occurred.

Referring back to FIG. 2, the last step in the set-up process (illustrated in in FIG. 1) is the custodian identifier process 207. This process is configured to determine the likelihood the custodian provided by the shareholder is the actual custodian. Because investors, especially those that are sophisticated and influential, tend to “spread” their shares across a number of custodians, identifying the custodian(s) associated with a particular investor allows the system to track investor trading activity with more precision.

In one embodiment, custodian identifier process 207 uses an approach that leverages data captured in a primary security offering. As discussed above, in a PIPE transaction, the investor, the shares, and the custodian are all known to the issuing company. The custodian identifier process 207 is configured to determine a likelihood a custodian identified in the primary security offering is the actual custodian of the shareholder.

As illustrated in FIG. 5, custodian identification process begins by retrieving the primary security offering transactional details in 501. This data is used to obtain the name of the custodian and custodian statistical features (e.g., custodian share count statistic, such as those illustrated in FIGS. 4A-4C) in 503. Using custodian statistical features, the custodian identification process determines whether the Temporal Attention Mechanism (TAM) can detect the occurrence of additional shares at the custodian in 505. In other words, the custodian identification process confirms whether the custodian indicated in the primary security offering data is the actual custodian.

If TAM cannot detect the occurrence of additional shares at the custodian in 505, the primary security offering data stored in the Deal Center database is updated to reflect that the custodian identified by the shareholder has a medium likelihood of being the actual custodian. Alternatively, in the affirmative case, the TAM test is applied to the available custodian time-series data in 507. Upon the TAM test identifying a TAM Event, the primary security offering data stored in the Deal Center database is updated to reflect that the custodian identified by the shareholder is highly likely to be the actual custodian.

However, if the TAM test fails to identify a TAM Event, the process attempts to determine whether the Owner immediately transferred shares to another custodian. Often, a more sophisticated investor will request the shares to be delivered to a custodian defined in the transaction, only to immediately transfer the shares to one or more different custodians. Upon determining that the custodian should have experienced a TAM Event (by virtue of expected share transfer) but failed to register the shares, the process determines whether a custodian change has occurred at 509. Upon determining that the custodian change occurred by reviewing all custodians for a correlated TAM Event at 511, the primary security offering data stored in the Deal Center database is updated to reflect that the custodian identified by the shareholder is highly likely to be the actual custodian. Alternatively, the process determines whether a splitting of shares over multiple custodians took place at 513.

Upon determining that the shares were likely split across multiple custodians by determining that one or more share range histogram statistics experienced a TAM Event at 515, all custodians with histogram outlier events are obtained at 517. Each of the custodians identified is then examined for a correlated share count TAM Event at 519. Each custodian having a determination of a share count TAM Event (e.g., a correlation between share count and TAM event is determined) is identified as the likely custodian of record for the shareholder and a high confidence score is assigned at 521. By contrast, upon determining that no share count TAM Event is associated with a custodian, that custodian is assigned a medium confidence score at 523.

In another embodiment, custodian identifier process 207 uses an approach leveraging data from the NOBO report. As explained earlier, the NOBO report provides limited information about the relationship between the NOBOs and the custodians by virtue of being obtained at irregular intervals. By using the NOBO approach, the custodian identifier process 207 is configured to determine a likelihood a NOBO is associated with a particular custodian.

The process obtains the NOBO report. The data obtained in the NOBO may include: a number of shares owned by each NOBO, identified as matrix A₁, a total number of shares in each custodian, identified as matrix B₁, and a number of NOBOs in each custodian, identified as matrix B₂. Based on these identifications, a system of linear simultaneous equations can be formed, where A₂ is a 1 by n matrix, and x is a map that needs to be solved:

A₁x==B₁

A₂x=B₂

The x matrix contains only 0s and 1s. In addition, the following four constraints have to be taken into consideration: (1) each NOBO can only appear in at most one custodian, (2) each NOBO needs to be on at least one custodian, (3) the number of NOBO shares is an integer and a non-negative number, and (4) this system always has at least one solution.

This approach will not generate a unique solution. Any number of NOBOs with the same number of shares can be exchange between any two custodians, thus creating another solution. For example, if there are more than one NOBO with the same number of shares, then we know that we can exchange the position of these two NOBOs between custodians to create another solution. For example:

custodian A=NOBO₁+NOBO₂

custodian B=NOBO₃+NOBO₄

If the shares of NOBO₁ and NOBO₂ are equal to the share of NOBO₃+NOBO₄, then:

custodian A=NOBO₃+NOBO₄, and

custodian B=NOBO₁+NOBO₂

Accordingly, more than solution may be generated.

In one embodiment, the problem may be solved using the knapsack-based decomposition approach. This algorithm decomposes the problem into a series of knapsack problems, which requires all the knapsacks to be filled instead of just a single knapsack.

Here, the knapsack problem is defined by N and it contains i items, where N={1, 2, 3, . . . N} as a set of items. Each item has its associated weight Wᵢ and value Vᵢ and the knapsack can only take a total of weight of W. The goal is to maximize the total value from the items that can be put into the knapsack. For example, the following knapsack problem formula may be applied:

max Σ₁ⁿ ViYi, so that Σᵢⁿ WiYi≤W, where Yₙ∈{0,1}

In some embodiments, the following pseudocode for the traditional Knapsack problem may be used:

```
knapsack(n, v[1..n], w[1..n], W)
  for i in range (0,W): V[0,i] = 0
  for i in range (1,n):
    for j in range(0,W):
      leave = v[i−1,j]
      if (j >= w[i]):
        take = v[i] + V[i−1, j−w[i]]
      else:
        take = 0
      V[i,j] = max(leave, take)
  return V[n,W]
```

In some embodiments, a linear optimization solver may be used to estimate the optimal solution for the multiple knapsack problem when determining a likelihood that a NOBO is associated with a particular custodian. By using linear optimization, the solution may be obtained faster and without incurring significant processing costs traditionally associated with processing a knapsack problem, a np-complete problem, despite the extra contractions to narrow down the number of solutions.

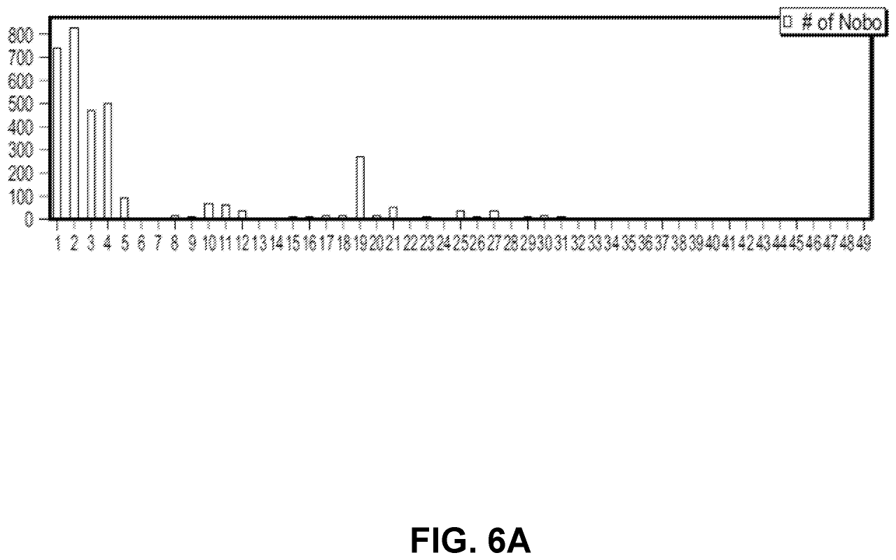

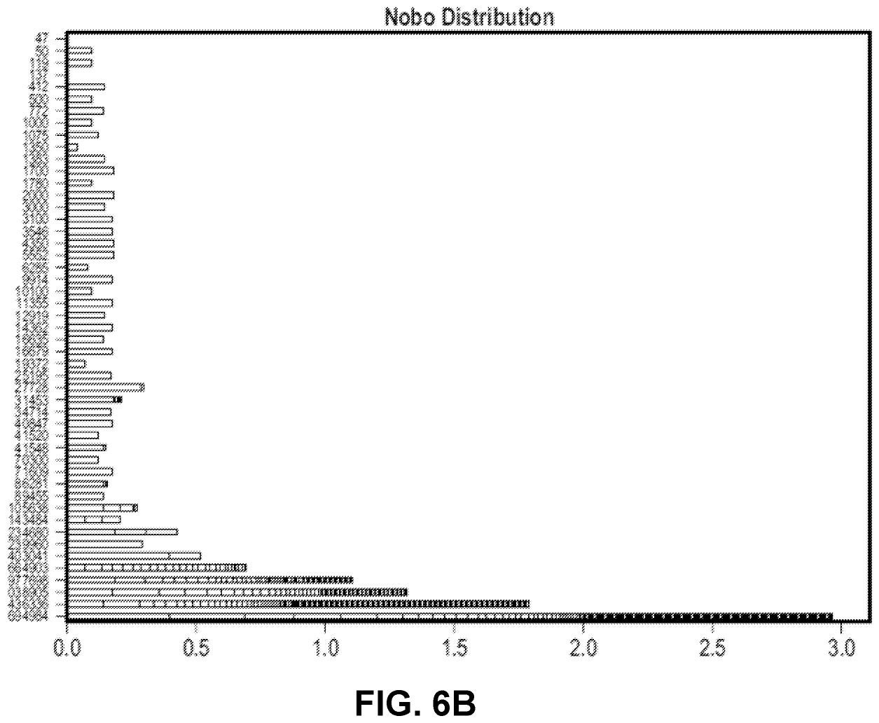

As illustrated in FIG. 6A, an example report demonstrates the results of using the NOBO approach to determine which NOBO is associated with which custodian. In this particular example, 3,300 NOBOs (represented by the bar graphs) are assigned to one of fifty custodians (identified by a label on the x-axis). The same results can be represented as a NOBO distribution report illustration FIG. 6B. Differently shaded sections within the same bar identify distinct NOBOs.

By using this approach, the method may determine a likelihood a NOBO is associated with a particular custodian. The NOBOs with higher likelihood ranges may be assigned a custodian based on this analysis. The primary security offering data stored in the Deal Center database may be updated to reflect this new custodian determination.

Referring back to FIG. 1, instruction 108 executed by hardware processor 104 may perform the monitoring process. The monitoring process may begin upon completing the set-up process. During the monitoring process, features of shareholder and custodian profiles may be actively monitored utilizing a Temporal Attention Mechanism (TAM). The monitoring process may be iterative and continue until an event determined by TAM (e.g., a TAM Event) is detected (e.g., upon executing instruction 110). In some embodiments, the monitoring process may be triggered each time new custodian data (e.g., an SPR report) is available to the system. Alternatively, the monitoring process may be executed periodically at a particular frequency.

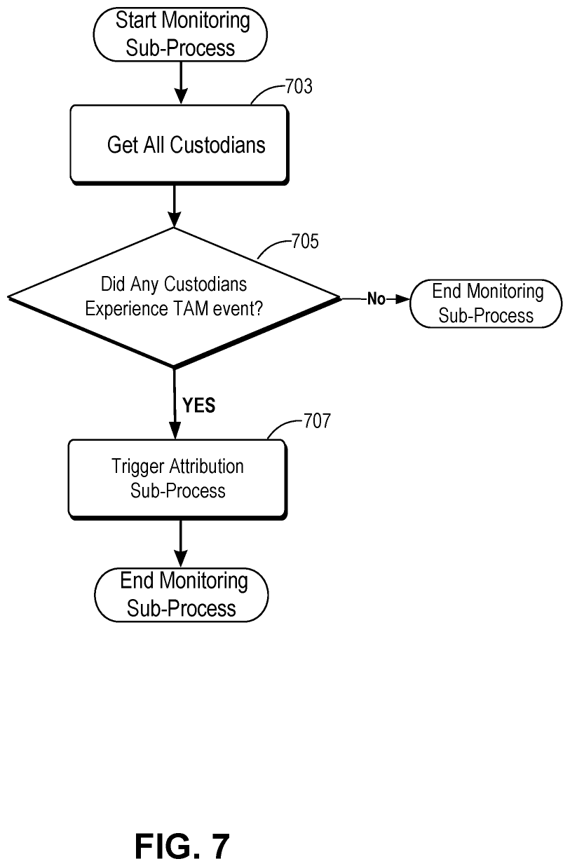

An example monitoring process is illustrated in FIG. 7. In this example, custodian share count data may be obtained in 703. Upon determining that no custodians experienced a TAM Event in 705, the monitoring process may end. Alternatively, upon determining that custodians experienced a TAM Event in 705, for example as described above with reference to FIG. 5, the attribution process 707 may be initiated. Additionally, based on the detection that TAM Event occurred, based on the frequency of the SPRs reports as obtained and potentially under-sampled data, SPR reports may be ordered for the missing time-series data values to more accurately determine the date of when the TAM Event occurred.

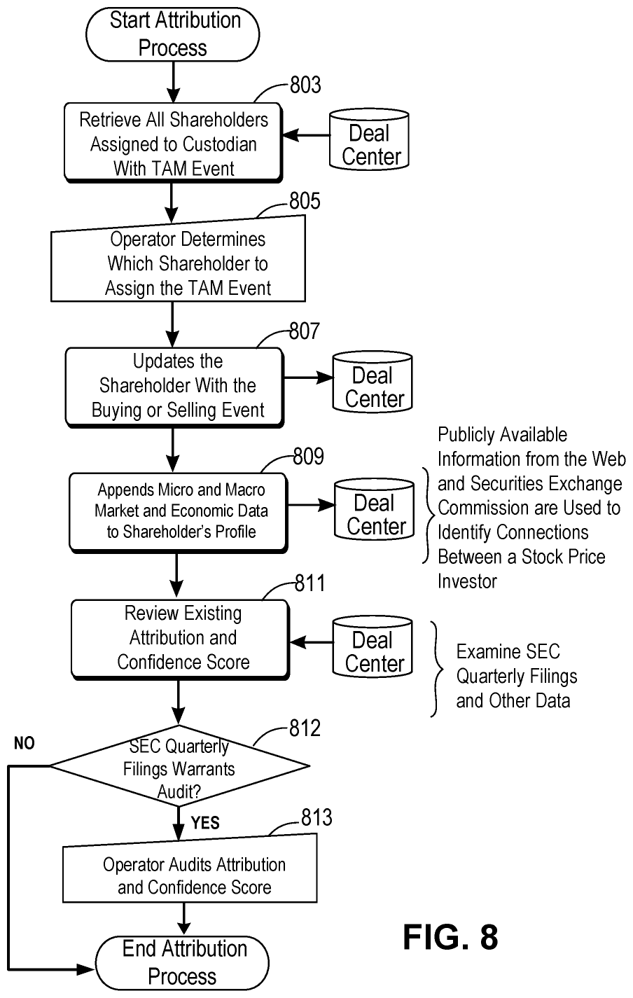

Referring back to FIG. 1, instruction 112 executed by hardware processor 104 may perform the attribution process upon detecting the TAM Event. The attribution process may generate and present the user with a set of likely investor candidates that the user will then finalize by making a final investor candidacy determination by attributing each investor candidate's buying/selling behavior. An example attribution process is illustrated in FIG. 8. At 803, the attribution process retrieves all shareholders assigned to a custodian experiencing a TAM Event (e.g., statistically significant activity). At step 805, the operator uses and inductive reasoning process to determine which shareholder to assign the TAM event. To assist the operator in the inductive reasoning process, as described below, in some embodiments shareholder candidates along with the information known and/or attributed to that candidate is presented to the operator. At 807, the operator makes a selection of which shareholder to assign the buying or selling event that led to the TAM event. At 809, the process appends micro- and macro-market and economic data to shareholder's profile. Next, at 811, the process reviews existing attribution and confidence score data. Further, at 812, the process determines whether the SEC quarterly filings warrant the audit. Finally, at 813, upon determining that the SEC quarterly filings warrant the audit, the operator audits attribution and confidence scores are determined by the process.

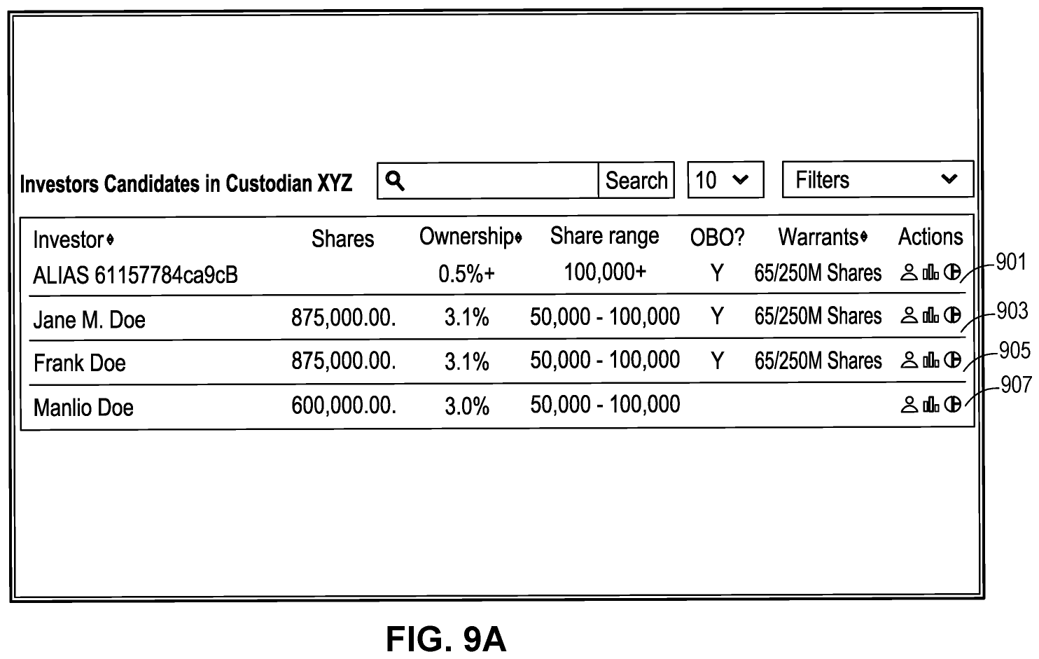

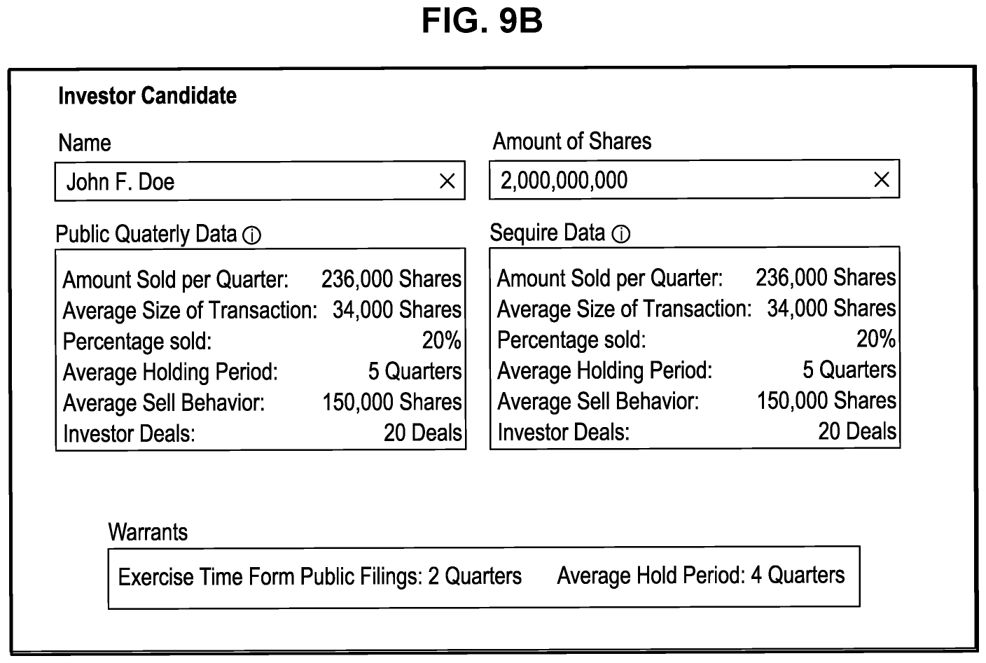

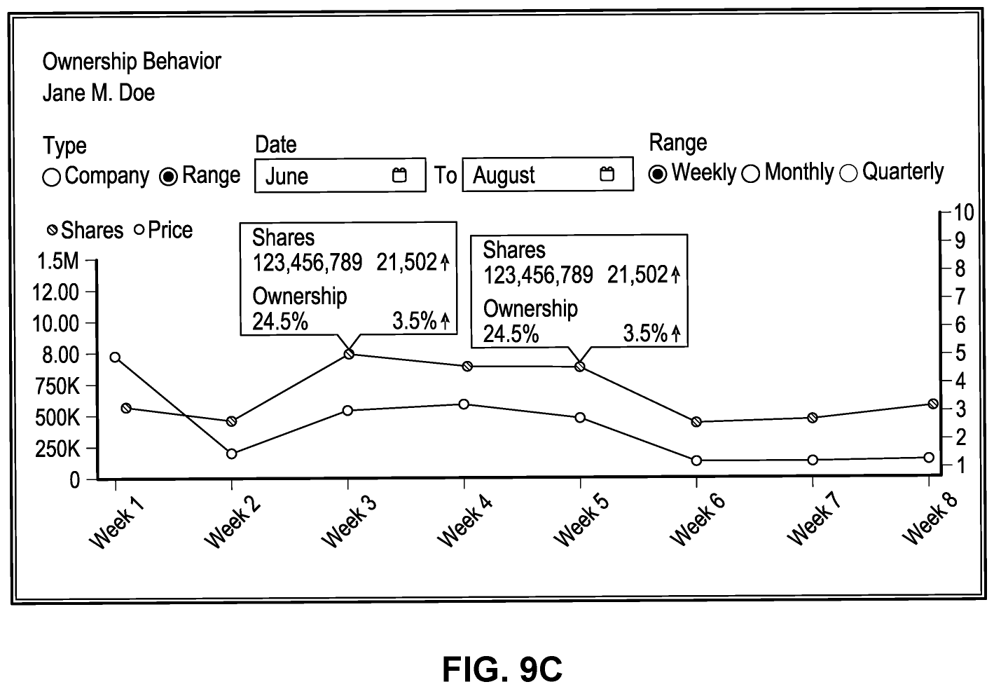

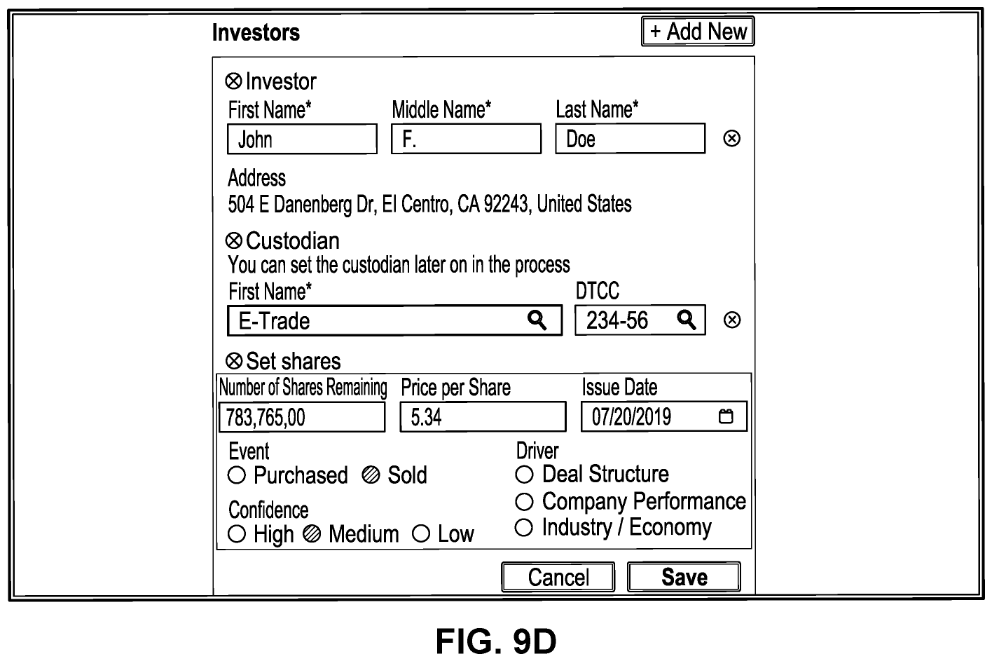

FIG. 9A illustrates investor/shareholder candidates with a summary of known estimates generated by the attribution process. Investor/shareholder candidates 901, 903, 905, and 907 are presented to the operator to conduct their inductive analysis. Note, candidates 903, 905, and 907 are identified non-anonymous OBOs while candidate 901 is unidentified anonymous identified using an ‘Alias’ name.

Next, to assist the operator in the inductive analysis, information for each shareholder under consideration is provided. For example, as illustrated in FIG. 9B, data in primary equity offering, all historic transactions previously attributed to the shareholder, all publicly available data in the form of current and past investments (e.g., from SEC Forms 13G and 13F), data indicating whether the shareholder is an institutional investor, shareholder's investment portfolio, and their investment thesis (e.g., buy & hold, short-squeezer, day-trader, etc.) is presented.

Further, an “investor snapshot” of all known buying and selling statistics as well as ownership behavior is presented to the user, as illustrated in FIGS. 9B-9C, for example.

In FIG. 9D, the operator uses inductive reasoning to determine which investor should be attributed to the buying or selling activity. Due to the nature of the TAM, the exact number of shares in a transaction is not precisely known and thus the operator can suggest the level of confidence in the attribution assignment. Additionally, in some embodiments the operator makes an assessment as to the driver leading to the investor's selling/buying decision. These drivers include micro and macro factors such as the investor's warrants are expiring or the performance of the company, the industry or the economic sector, and it is important to understand the driver in order to classify the type of investor. Finally, FIG. 9D illustrates an example electronic form present in some embodiments that is presented to the operator to assign the attribution of a sale based on the information presented to the user in FIGS. 9A-9C.

In some embodiments, the system may periodically retrieve SEC filings, such as Form 13G, or present any applicable NOBO reports which represent an investor's reported share ownership, for a particular investor. While these sources are still vulnerable to the sampling issue, the data therein can be used to collaborate on going trends. The system examines the SEC filings and upon determining that the company has filed a 13G, alerts the user to audit entered attributions of said investor.

In some embodiments, the attribution process may be configured to automatically assign trading signal data to a shareholder. For example, the attribution process may be trained using the manual shareholder assignment by periodically randomly splitting the data into training and predicted values. In some embodiments, the attribution process may provide the securities issuer a warning that the outcome of the delta between learned and predicted is high. For example, this data may be used as additional training data to attribute the buying/selling decision.

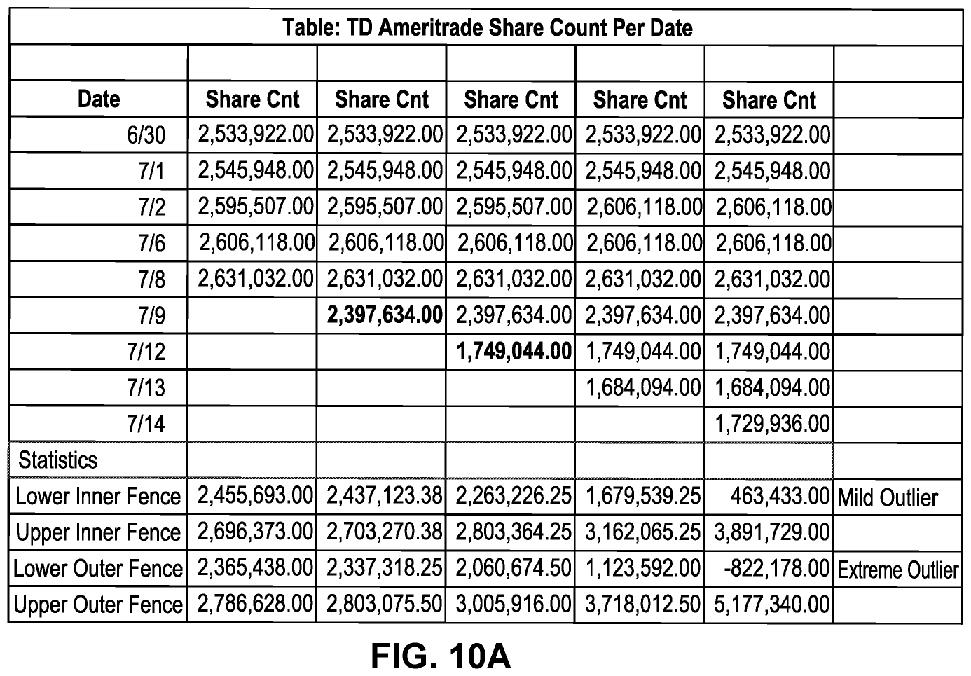

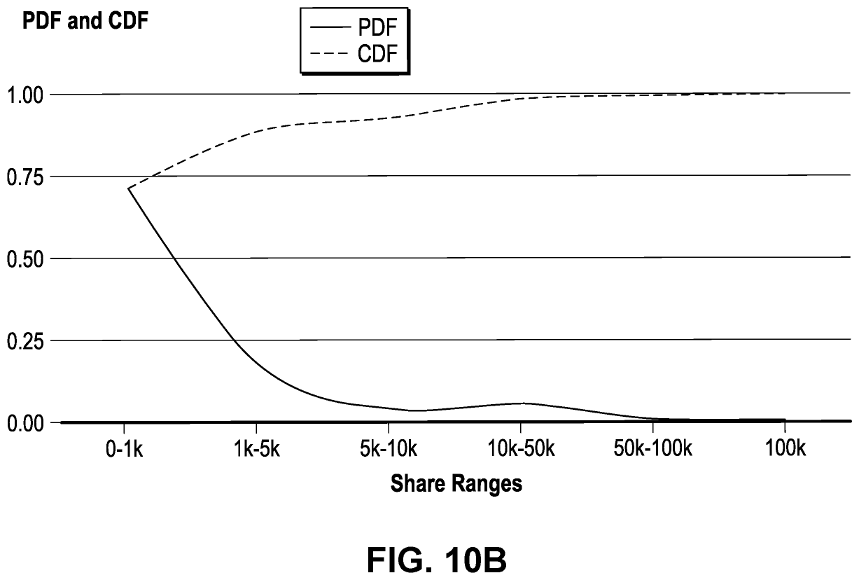

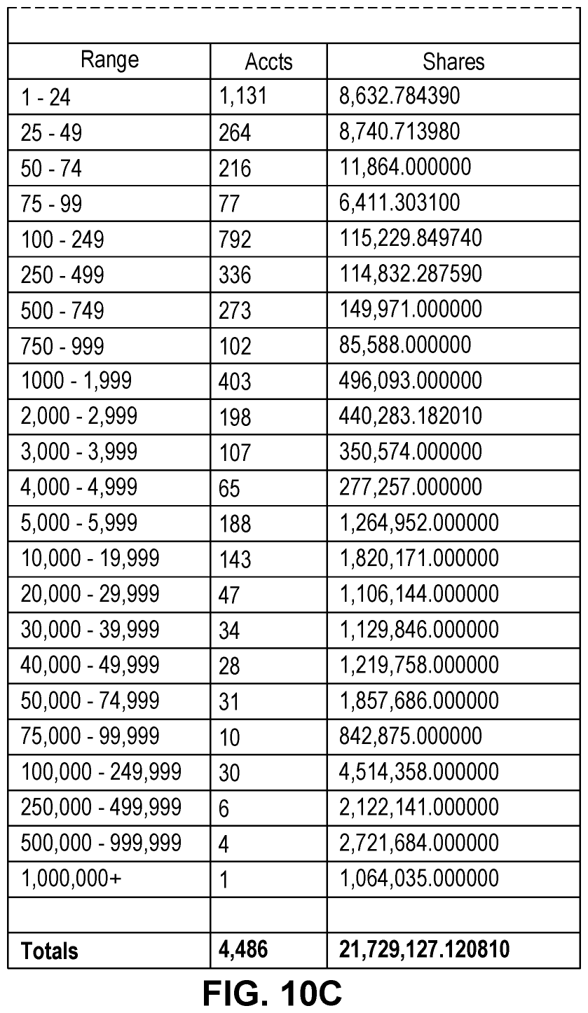

The following is an example of the custodian identifier system implemented using real life custodian share counts. For example, FIG. 10A illustrates share count statistics for an example custodian (TD Ameritrade). In this instance, both the inner fence and the outer fences of an example custodian for a given company are displayed. These values are derived from the last several days of trading. Notably, the share counts on July 9 and July 12 appear as statistical outliers. By virtue of being statistical outliers, these days represent a TAM Event. In this specific case, for example, an investor sold off a large number of shares. While TAM only detects unusual activity, it is possible, through inductive reasoning, to determine the correct shareholder that corresponds to the underlying TAM event. For example, a probability density function for a given security, as illustrated in FIG. 10B, suggests that very few shareholders have large quantities of shares. When the share count exceeds 300K, it can be easily observed that the probability of a shareholder having more than 100K is nearly zero. Moreover, it is typical that the top five percent of shareholders leverage the primary equity offerings, thus the shareholder and its name is already in the database 118.

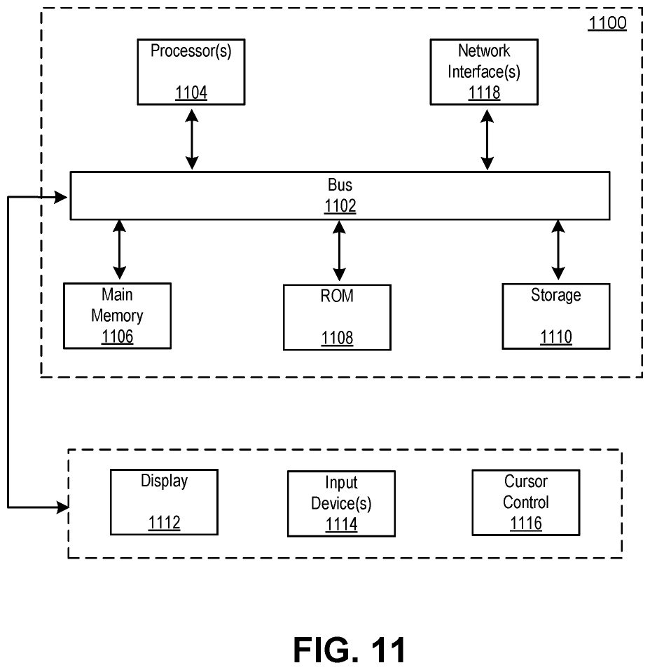

FIG. 10C illustrates an example histogram share range counts for an underlying security. The data indicates that there are only eleven shareholders (bottom three rows) that have in excess of 250,000 shares. By providing the operator (i.e., securities issuer) with a histogram, an embodiment enables and assists the securities issuer in conducting its analysis when determining the shareholder.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 11. Various embodiments are described in terms of this example computing module 1100. After reading this description, it will become apparent to a person skilled in the relevant art how to implement the technology using other logical circuits or architectures.

FIG. 11 illustrates an example computing module 1100, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 11. Various embodiments are described in terms of this example-computing module 1100. After reading this description, it will become apparent to a person skilled in the relevant art how to implement the application using other computing modules or architectures.

Referring now to FIG. 11, computing module 1100 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 1100 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 1100 might include, for example, one or more processors, controllers, control modules, or other processing devices, such as a processor 1104. Processor 1104 might be implemented using a general-purpose or special-purpose processing engine such as, for example, a microprocessor, controller, or other control logic. In the illustrated example, processor 1104 is connected to a bus 1102, although any communication medium can be used to facilitate interaction with other components of computing module 1100 or to communicate externally. The bus 1102 may also be connected to other components such as a display 1112, input devices 1114, or cursor control 1116 to help facilitate interaction and communications between the processor and/or other components of the computing module 1100.

Computing module 1100 might also include one or more memory modules, simply referred to herein as main memory 1106. For example, preferably random-access memory (RAM) or other dynamic memory might be used for storing information and instructions to be executed by processor 1104. Main memory 1106 might also be used for storing temporary variables or other intermediate information during execution of instructions to be executed by processor 1104. Computing module 1100 might likewise include a read only memory (“ROM”) 1108 or other static storage device 1110 coupled to bus 1102 for storing static information and instructions for processor 1104.

Computing module 1100 might also include one or more various forms of information storage devices 1110, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 1110 might include other similar instrumentalities for allowing computer programs or other instructions or data to be loaded into computing module 1100. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 1100.

Computing module 1100 might also include a communications interface or network interface(s) 1118. Communications or network interface(s) interface 1118 might be used to allow software and data to be transferred between computing module 1100 and external devices. Examples of communications interface or network interface(s) 1118 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 1118 might typically be carried on signals, which can be electronic, electromagnetic (which includes optical) or other signals capable of being exchanged by a given communications interface. These signals might be provided to communications interface 1118 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 1106, ROM 1108, and storage unit interface 1110. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1100 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for determining a shareholder identifier, the method comprising:
determining a significant event occurrence associated with a change in a daily closing share count held by a custodian of shares by processing, at a first frequency, custodian records of the custodian of shares comprising share count records associated with a security at the custodian of shares, the custodian of shares having a custodian identifier;
obtaining shareholder records associated with the significant event occurrence,
wherein the custodian identifier corresponds to the same custodian identifier associated with at least one shareholder record and at least one reference record, and wherein the shareholder record is associated with a transaction on a secondary market of the security and reference records are associated with a primary security offering; and
identifying at least one reference record for the at least one shareholder record associated with the determined significant event occurrence and the custodian identifier, the reference record comprising a shareholder identifier.

2. The method of claim 1, wherein the obtaining shareholder records associated with the significant event occurrence comprises:
identifying most likely shareholders by applying a probability density function to shareholder records associated with the security.

3. The method of claim 1, further comprising:
identifying at least one shareholder alias record for each obtained shareholder record without the corresponding reference record.

4. The method of claim 3, wherein the at least one shareholder alias record is generated for each obtained shareholder record associated with the significant event occurrence with missing reference record based on a share count range and the custodian identifier.

5. The method of claim 1, wherein the first frequency is non-daily.

6. The method of claim 1, wherein the first frequency is daily.

7. A computing apparatus for determining a shareholder identifier, comprising:
a processor;
a memory coupled to the processor; wherein the processor is configured to:
determine a significant event occurrence associated with a change in a daily closing share count held by a custodian of shares by processing, at a first frequency, custodian records of the custodian of shares comprising share count records associated with a security at the custodian of shares, the custodian of shares having a custodian identifier;
obtain shareholder records associated with the significant event occurrence,
wherein the custodian identifier corresponds to the same custodian identifier associated with the at least one shareholder record and at least one reference record, and wherein the shareholder record is associated with a transaction on a secondary market of the security and reference records are associated with a primary security offering; and
identify at least one reference record for the at least one shareholder record associated with the determined significant event occurrence and the custodian identifier, the reference record comprising a shareholder identifier.

8. The computing apparatus of claim 7, wherein the processor is further configured to identify most likely shareholders by applying a probability density function to shareholder records associated with the security.

9. The computing apparatus of claim 7, wherein the processor is further configured to identify at least one shareholder alias record for each obtained shareholder record without the corresponding reference record.

10. The computing apparatus of claim 9, wherein the at least one shareholder alias record is generated for each obtained shareholder record associated with the significant event occurrence with missing reference record based on a share count range and the custodian identifier.

11. The computing apparatus of claim 7, wherein the first frequency is non-daily.

12. The computing apparatus of claim 7, wherein the first frequency is daily.

13. A non-transitory computer-readable storage medium storing a plurality of instructions executable by one or more processors, the plurality of instructions when executed by the one or more processors cause the one or more processors to:
determine a significant event occurrence associated with a change in a daily closing share count held by a custodian of shares by processing, at a first frequency, custodian records of the custodian of shares comprising share count records associated with a security at the custodian of shares, the custodian of shares having a custodian identifier;
obtain shareholder records associated with the significant event occurrence,
wherein the custodian identifier corresponds to the same custodian identifier associated with at least one shareholder record and at least one reference record, and wherein the shareholder record is associated with a transaction on a secondary market of the security and reference records are associated with a primary security offering; and
identify at least one reference record for the at least one shareholder record associated with the determined significant event occurrence and the custodian identifier, the reference record comprising a shareholder identifier.

14. The computer-readable storage medium of claim 13, wherein the plurality of instructions when executed by the one or more processors further cause the one or more to identify most likely shareholders by applying a probability density function to shareholder records associated with the security.

15. The computer-readable storage medium of claim 13, wherein the plurality of instructions when executed by the one or more processors further cause the one or more processors to identify at least one shareholder alias record for each obtained shareholder record without the corresponding reference record.

16. The computer-readable storage medium of claim 15, wherein the at least one shareholder alias record is generated for each obtained shareholder record associated with the significant event occurrence with missing reference record based on a share count range and the custodian identifier

17. The computer-readable storage medium of claim 13, wherein the first frequency is non-daily.

18. The computer-readable storage medium of claim 13, wherein the first frequency is daily.
